(19) United States
(12) Patent Application Publication
(10) Pub. No.: US 2002/0165005 A1
(43) Pub. Date: Nov. 7, 2002

(54) Portable computing device

(75) Inventors: Paul Travers, Honeoye Falls, NY (US); Paul Churnetski, West Henrietta, NY (US); Daniel N. Menachof, Rochester, NY (US); Craig R. Travers, Honeoye Falls, NY (US); Geoffrey G. Furman, Rush, NY (US); Bryan J. Harkola, Fairport, NY (US); Stephen Glaser, Webster, NY (US); Stephen Karl Rapp, Rochester, NY (US); Grant N. Russell, Delta (CA)

Correspondence Address: Stephen B. Salai, Esq., Harter, Secrest & Emery LLP, 1600 Bausch & Lomb Place, Rochester, NY, 14604-2711, US

(73) Assignee: Interactive Imaging Systems, Inc., Rochester, NY

(21) Appl. No.: 10/091,018

(22) Filed: Mar. 5, 2002

Related U.S. Application Data
(63) Continuation-in-part of application No. 09/848,074, filed on May 3, 2001.

(51) Int. Cl. H04M 1/00

(52) U.S. Cl. 455/556; 455/550; 455/66

(57) ABSTRACT

A portable computing device with a microcomputer, a first display, a magnifying optical element through which the first display is viewed to provide a user with an enlarged virtual display, a first input device to communicate with the first display, a second direct display, and a second input device that can be a keyboard such that the second display can interact with the keyboard to display alphanumeric and other symbols so the user can see what is being typed. The second display is directly viewed and is configured to display the same data being entered in the selected field of the first display. Typically, the first display is a liquid crystal color display, capable of displaying a full range of text and graphic images such as can displayed on a conventional computer monitor. A virtual image of the first display is viewed by holding the lens close to an eye. To a user, the virtual image appears as large a real display provided on a conventional desktop or laptop.

### FIELD OF THE INVENTION

This application relates generally to a portable computing device and more particularly a hand held device that includes a large format virtual display, a keyboard, and a small format display displaying the information entered on the keyboard.

### BACKGROUND OF THE INVENTION

There is an increasing demand for portable computing devices. A variety of devices have been created to fulfill this demand including hand held computers of many kinds, such as personal digital assistants (PDAs).

Such devices frequently combine communications, computing and display capabilities. For example, mobile telephones have textual displays that can for example show e-mail messages. Other devices have graphic displays for showing truncated versions of images such as web pages accessed via the World Wide Web. In principle, compact personal communications devices with data processing and display capabilities can be regarded as miniaturized laptop computers. Hitherto, however, the small format required of the displays on personal communications devices have not provided users with the ability to view images in the detail provided on a conventional computer display.

Workers in various fields such as engine repair, police work, medicine, geography, geology, archaeology, and a host of others working in the field often require quick access to detailed information stored in a database available a local or wide area network—for example, engineering drawings, schematics or maps.

Therefore, there is a need for a handheld communications and computing device which provides users with a high-quality graphical display while retaining the advantage of being sufficiently portable to carry on one's person, for example in a pocket using a belt clip.

Furthermore, given a high quality graphical display in a handheld communications and computing device, there is also a need to provide such a device that facilitates the comfortable entry of data by a user.

### SUMMARY OF THE INVENTION

The present invention is a portable computing device. Features of the device include a microcomputer, a first display, a magnifying optical element such as a lens through which the first display is viewed to provide a user with an enlarged virtual display, and a first input device. Typically, the first display is a liquid crystal color display, capable of displaying a full range of text and graphic images such as can displayed on a conventional computer monitor. A virtual image of the first display is viewed by holding the lens close to an eye. To a user, the virtual image appears as large as a real display provided on a conventional desktop or laptop computer.

The first input device is typically a built-in mouse, with which the user can control the visual content of the display. The mouse can be used in the same way as in a conventional computer. In particular, the mouse could be used to enter data such as text or numerical information in a selected field.

If a considerable amount of data must be entered, using the mouse is often inconvenient. Therefore, a second input device, in particular a keyboard, is provided on the portable computing device. Typically, a user must withdraw the portable computing device from the eye to operate the keyboard, and will then be unable to see data being entered from the keyboard into the virtual display. Conventionally, this would be simple fore someone proficient at touch-typing. The problem is that many people are not adept at touch-typing. Furthermore, even an expert touch-typist would not find it easy on the portable computing device, given the compactness of the keyboard and the fact that portable computing device would not normally be firmly supported.

Therefore, the portable computing device has a directly-viewed second display that typically displays alphanumeric and other symbols such as mathematical operators. The second display is directly viewed and is configured to display the same data being entered in the selected field of the first display. Thus, the user can see what is being typed.

The portable computing device of the invention also has other features commonly found in other portable computing devices.

In summary, the portable computing device provides a virtual display magnified relative to the first display, and is configured to allow the options of data entry either while viewing the virtual display, using the mouse, or while viewing the second display, using the keyboard.

### BRIEF DESCRIPTION OF THE DRAWINGS

FIG. 1 is a top plan view of a portable computing device in a first embodiment, having a housing and a display located within the housing.

FIG. 2 is a bottom plan view of the portable computing device of FIG. 1.

FIG. 3 is a block diagram showing elements of the portable computing device.

FIG. 4 is a schematic showing a virtual image formed by magnifying an image from the portable computing device with an optical element.

FIG. 5 shows an image displayed by the portable computing device, the image including a virtual keyboard.

FIG. 6 is a schematic showing the portable computing device of FIG. 1 having wired connections to a network and to another device.

FIG. 7 is a schematic showing the portable computing device of FIG. 1 wirelessly connected to a network and to another device.

FIG. 8 is a schematic showing a second embodiment of the portable computing device, in which the display is located outside the housing and is mounted on a spectacle frame.

FIG. 9 is a schematic showing a second embodiment of the portable computing device, in which the display is located outside the housing and is part of a headset.

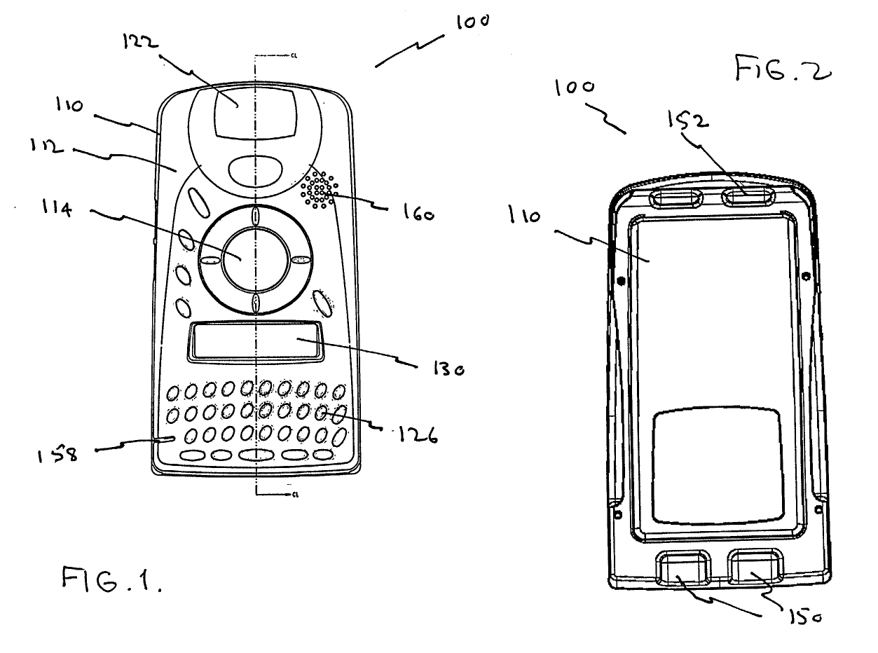

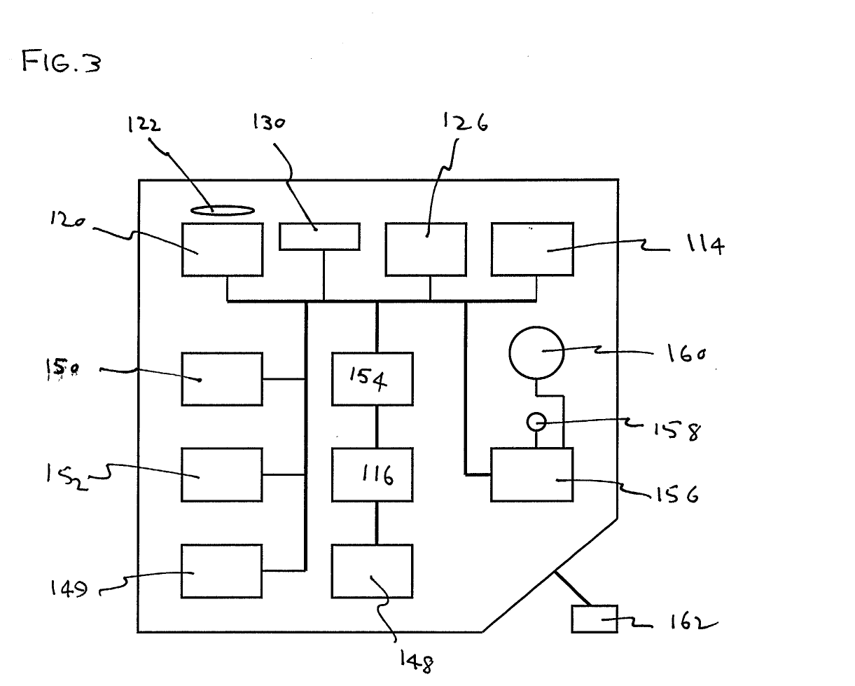

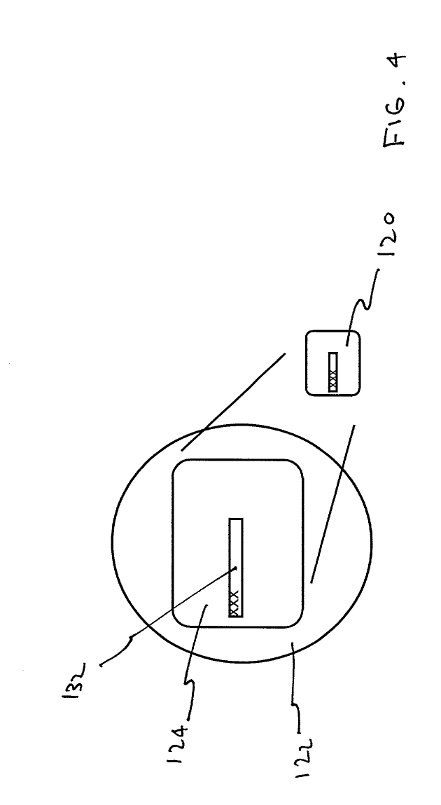

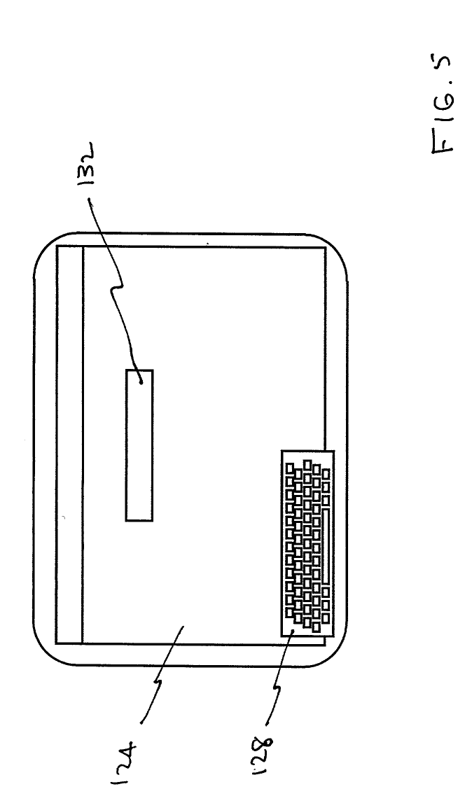

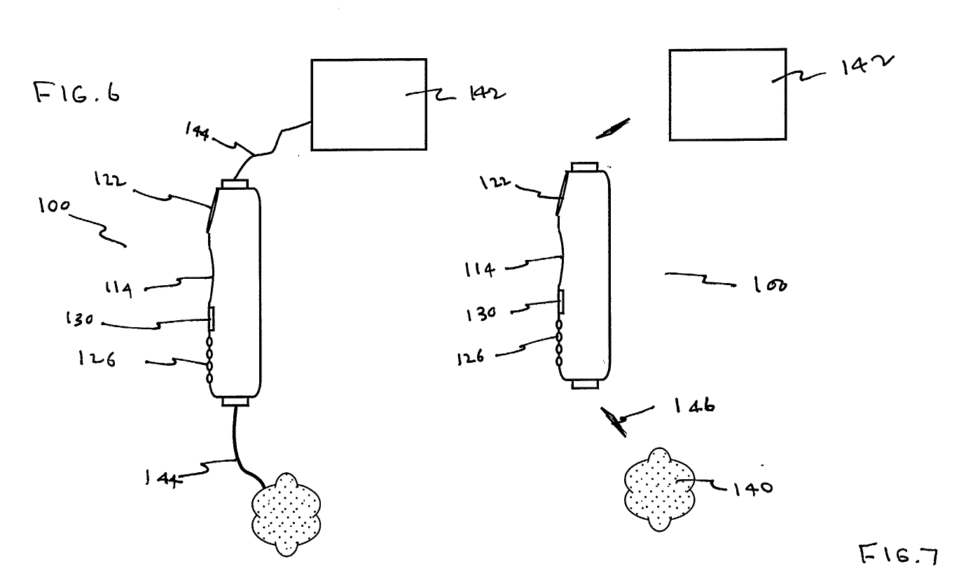

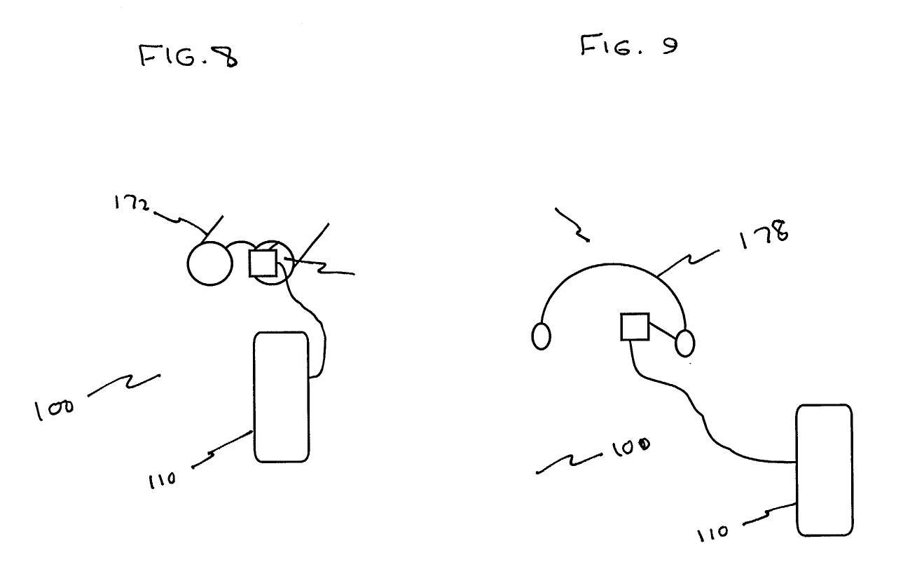

### DETAILED DESCRIPTION OF THE INVENTION

Referring to the drawings, a portable computing device 100 in a first embodiment has a housing 110 with a top surface 112; a first input device or pointing device, which can be a scroll wheel but is preferably a mouse 114 and most preferably an optical mouse; a central processing unit or microcomputer 116; an illuminated first display 120; and a magnifying optical element such as a lens 122 set into the top surface 112. The mouse 114 resides in the top surface 112, in a depression configured to accept a user's thumb. The first display 120 is typically a small format liquid crystal colorfield sequential display set within the housing 110. This particular array is commonly referred to as a VGA display. To allow the portable computing device 100 to be used in a variety conditions, the housing 110 is electrically and thermally insulating, and can be made water- and shock-resistant.

The first display 120 is basically functions like a monitor of a conventional desktop or laptop computer, can typically show any graphic, textual or other information that can normally be viewed thereon, and responds similarly to the conventional monitor to any given command or input. The first display 120 responds to the mouse 114 or any other input device connected to the first display 120 via the microcomputer 116.

The first display 120 is selected for its high resolution. However, its small format does not lend itself to direct viewing. Therefore, the portable computing device 100 is configured to be used by bringing the lens 122 close an eye and viewing a magnified image of the first display 120 therethrough, the magnified image being referred to as a virtual image 124. In the typical portable computing device 100 of this invention, the first display 120 has a 640×480 pixel array and measures about 0.4 inch (10 mm) along a diagonal, but to the viewer, the virtual image 124 seen through the lens 122 resembles a 21″ (525 mm) diagonal monitor viewed from about 3.7 feet (1.1 m) away. Enlarged virtual images such as 124 may be defined as life-sized.

The portable computing device 100 also has a second input device, usually in the form of a keyboard 126 located on the top surface 112. The keyboard 126 can function like a conventional computer keyboard, although it is scaled down to fit the housing 110. The portable computing device 100 usually has software enabling a virtual keyboard 128 to be selectably displayed and used in the first display 120, input to the virtual keyboard being provided from the built-in mouse 114.

Despite the convenience provided by the magnified virtual image 124, data entry using the virtual keyboard 128 and the built-in mouse 114 can be awkward if considerable input is required. The intrinsic convenience of the keyboard 126 is largely nullified, since it is difficult to view the virtual image 124 and the keyboard 126 simultaneously. It is therefore impractical for the user to follow in the virtual image 124 what is being typed on the keyboard 126.

To solve this problem, the portable computing device 100 also has a second display 130. This is typically a direct-view LCD screen, primarily configured to show symbols such as letters, numerals and mathematical operators, although it could also show other indicia such as geometric shapes or directional indicators. The second display 130 can be selected to show a single line or a few lines of text. A user wishing to enter text into a given field 132 views the virtual image 124 through the lens 122 and selects that field 132 using the built-in mouse 114, just as a user of a conventional computer using a mouse. The required text can then be entered with the keyboard 126, the text appearing on the second display 130 simultaneously with its appearance in the selected field 132. Thus, the user can see what is being typed.

To enter data such as text into the selected field 132, the user may enter a command with the built-in mouse 114 to cause the virtual keyboard 128 to be displayed. Once the virtual keyboard 128 appears, the user may then enter in any required input that can be entered with a conventional keyboard. However, this may be inconvenient if a large amount of input is required. A more convenient alternative is for the viewer to provide the input with the keyboard 126 while viewing the second display 130. Once this particular input is complete, the user reverts to viewing the virtual image 124 knowing that the selected field 132 of the virtual image 124 will have the same content as was viewed on the second display 130.

The portable computing device can communicate with a local or wide area network 140 and with external devices 142 via wired connections 144 or wireless connections 146. The wireless connections are effected by radio frequency or infrared transceivers.

As seen in the block diagram of FIG. 3, elements of the portable communications device 100 can include a basic memory RAM/ROM/Flash card 148, serial ports 149, compact flash slots 150, an infrared port 152, field programmable gate array logic 154, analog interface electronics 156, and audio components such as a microphone 158 and speaker 160, and a power subsystem 162 which can include a battery or an AC power input. The compact flash slots 150 can accept compact flash cards which can for example be modem, Ethernet, serial, BlueTooth wireless, or digital phone cards, USB, or laser scanners. They can also accept additional memory cards. Optionally, a wireless transceiver may be provided within the housing and connected to the microcomputer 116.

Referring further to FIG. 3, the device includes a microprocessor which may be fast low-power consumption microprocessor 116. Internal memory including random access memory, read only memory and flash reprogrammable memory is connected to the microprocessor 116 by conventional data and instruction bus. The microprocessor 116 is connected to other elements of the portable computing device 100 by way of a field programmable gate array (FPGA) logic chip 154. The FPGA 154 is connected to peripheral devices by a bus. The peripheral devices include one or more serial ports such as a universal serial bus port sand RS-232 ports 149 for connecting external devices 142. An infrared port, 152 such as an irVA port may optionally be connected to the FPGA 154. One or more compact flash slots 150 which can receive flash or other memory or other devices having similar interfaces is also provided. The CF slot protocol is conveniently used for these slots.

The first display 120 is a graphical character display is connected to the FPGA 154. Preferably, the graphical character display 120 shows characters typed on the QWERTY keyboard also connected to the bus. The graphical character display 120 can show other items such as text pages, telephone numbers and the like.

The keyboard 126 is a miniature QWERTY keyboard mounted on the housing 110 and connected to the bus. The 114 mouse and one or more programmable or non-programmable function keys is also connected to the bus. An analog interface chip having connections for an internal or external microphone and speaker is connected to the bus. Preferably, the microphone and speaker are disposed within the case and an additional connector for an external mike and speaker is provided.

The power supply sub system is connected to each of the components of the portable computing device by connections omitted from the drawing for purposes of clarity. Preferably, a rechargeable battery such as lithum ion batteries is provided along with a charger for connection to conventional household AC source, an external charger, car battery or the like.

In a second embodiment, the first display 120 and magnifying lens 122 are combined in a monocular assembly 170 located outside the housing 110 of the portable computing device 100, and worn on the user's head. In one configuration the assembly 170 is clipped onto a spectacle frame 172 worn by the user, such that the magnifying lens 122 is disposed between the first display 120 and a spectacle lens 174. Depending on the user, the spectacle lens 174 could be a prescription or a non-prescription lens. The display/lens assembly 170 is electrically connected to the remaining circuitry of the portable-computing device 100 exactly as in the first embodiment. In another configuration, the assembly 170 is part of a headset 176 including a band 178 fitting the user head and an arm 180. The assembly 170 is mounted on one end of the arm 180 and can be adjusted to a preferred position in front of one of the user's eyes. The second embodiment enables hands-free use of the portable-computing device 100. For example, having downloaded a desired schematic or page of instructions, a car-repair mechanic can view the virtual image 124 while working under a car.

While we have described the invention in connection with certain embodiments, we are aware that numerous and extensive departures may be made therein without however departing from the spirit of the invention and the scope of the appended claims.

What is claimed:

1. A portable computing device comprising:
a housing having a size and configuration compatible with handheld operation by a user, the housing having a first surface;
a microcomputer within the housing;
a first illuminated high-resolution display within the housing, and connected to the microcomputer;
maginfying optics adjacent the first surface and the first display and producing a life-sized, virtual image;
a keyboard on the first surface; and
a second display connected to the microcomputer and responsive to the keyboard and producing a direct-view image.

2. The computing device of claim 1 comprising a pointing device on the housing connected to the microcomputer.

3. The computing device of claim 2 in which the pointing device is a mouse.

4. The computing device of claim 3, wherein the mouse is an optical mouse connected to the microcomputer.

5. The computing device of claim 4 comprising a wireless data receiver within the housing and connected to the microcomputer.

6. The computing device of claim 4 comprising a voice responsive transducer on the housing and a voice recognition circuit within the housing coupled to the microcomputer.

7. The computing device of claim 4 comprising at least one serial port on the housing and connected to the microcomputer.

8. The computing device of claim 5 in which the wireless data receiver comprises an infrared receiver within the housing and further comprising an infrared transducer on the housing.

9. The computing device of claim 1, wherein the housing is water-resistant and shock resistant.

10. The computing device of claim 9, wherein the housing is an electrical and thermal insulator.

11. The computing device of claim 4, the virtual display further comprising a virtual keyboard.

12. The computing device of claim 1 comprising a input/output connector, and an earpiece/microphone combination connected to the input/output connector.

13. The computing device of claim 12 in which the earpiece/microphone combination comprises a headset.

14. The computing device of claim 13 in which the headset comprises a visible display.

15. The computing device of claim 1 comprising a plurality of programmable keys on the housing and connected to the microcomputer.

16. The computing device of claim 1 comprising a memory connector on the housing connected to the microcomputer.

17. The computing device of claim 1 comprising a speaker within the housing.

18. The computing device of claim 2 in which the pointing device comprises a scroll wheel.

19. The computing device of claim 5 in which the wireless data receiver comprises a radio transceiver.

20. A portable computing device comprising:
a housing having a size and configuration compatible with handheld operation by a user, the housing having a first surface;
a microcomputer within the housing;
a first illuminated high resolution display in communication with the microcomputer;
maginfying optics adjacent the first display and producing a life-sized, virtual image;
a keyboard on the first surface; and
a second display connected to the microcomputer and responsive to the keyboard and producing a direct-view image.

21. The computing device of claim 20 comprising a headset containing the first illuminated high resolution display.

22. The computing device of claim 21 in which the headset includes a headband.

23. The computing device of claim 21, wherein the headset has a communications port.

24. The computing device of claim 23 comprising a wireless data receiver within the housing and connected to the microcomputer.

25. The computing device of claim 23 comprising a voice responsive transducer on the housing and a voice recognition circuit within the housing coupled to the microcomputer.

26. The computing device of claim 23 comprising at least one communications port on the housing and connected to the microcomputer.

27. The computing device of claim 24 in which the wireless data receiver comprises an infrared receiver within the housing and further comprising an infrared transducer on the housing.

28. The computing device of claim 20, wherein the housing is water-resistant and shock resistant.

29. The computing device of claim 28, wherein the housing is an electrical and thermal insulator.

30. The computing device of claim 20, the virtual display further comprising a virtual keyboard.

31. The computing device of claim 20 comprising a input/output connector, and an earpiece/microphone combination connected to the input/output connector.

32. The computing device of claim 31 in which the earpiece/microphone combination comprises a headset.

33. The computing device of claim 20 comprising a plurality of programmable keys on the housing and connected to the microcomputer.

34. The computing device of claim 20 comprising a memory connector on the housing connected to the microcomputer.

35. The computing device of claim 20 comprising a speaker within the housing.

36. The computing device of claim 24 in which the wireless data receiver comprises a radio transceiver.
